(19) United States
(12) Patent Application Publication
(10) Pub. No.: US 2011/0182582 A1
(43) Pub. Date: Jul. 28, 2011

(54) JOINT SAMPLE RATE CONVERSION AND CD COMPENSATION IN FREQUENCY DOMAIN FOR COHERENT POLMUX

(75) Inventors: Kai YANG, PRINCETON, NJ (US); Ting WANG, PRINCETON, NJ (US)

(73) Assignee: NEC LABORATORIES AMERICA INC., PRINCETON, NJ (US)

(21) Appl. No.: 12/712,723

(22) Filed: Feb. 25, 2010

Related U.S. Application Data
(60) Provisional application No. 61/169,362, filed on Apr. 15, 2009.

(51) Int. Cl. H04J 14/06

(52) U.S. Cl. 398/65

(57) ABSTRACT

A combined CD compensation and sample rate conversion method performed in the frequency domain.

### CROSS REFERENCE TO RELATED APPLICATION

This application claims the benefit of U.S. Provisional Patent Application No. 61/169,362 filed Apr. 15, 2009 which is incorporated by reference as if set forth at length herein.

### FIELD OF DISCLOSURE

This disclosure relates to the field of telecommunications and in particular to method for converting a signal from one sampling frequency to another while not substantially affecting any information carried by the signal.

### BACKGROUND OF DISCLOSURE

Polarization multiplexing (PolMux) is a technique attracting attention for use in fiber optic systems employing coherent detection for high-speed (40 GB/s and above) transmission. A key component of such coherent detection PolMux systems is a high-speed analog to digital converter (ADC). As is known, an ACD converts an analog signal to a digital signal while periodically sampling the analog signal.

As may be readily appreciated by those skilled in the art, the sampling rate may ideally be an integral time of the symbol rate, which may facilitate any digital signal processing such as clock recovery and equalization. However, the sampling rate of an ADC is oftentimes pre-determined and cannot be adjusted. Accordingly, a method for converting the signal from one sampling frequency to another sampling frequency while not affecting any information carried by the signal would represent an advance in the art.

### SUMMARY OF DISCLOSURE

An advance is made in the art according to an aspect of the present invention directed to a combined CD compensation and sample rate conversion method performed in the frequency domain. Operationally, the method advantageously employs only a single fast-fourier transform (FFT), a single inverse FFT, and multiplications for both CD compensation and sample rate conversion.

In sharp contrast to prior art methods, the method according to the present invention combines two functional units—for example CD compensation and rate conversion—into one functional unit thereby providing a less complex and easier to implement system.

### BRIEF DESCRIPTION OF THE DRAWING

A more complete understanding of the disclosure may be realized by reference to the accompanying drawing in which:

FIG. 1 is a schematic diagram depicting sample rate conversion;

FIG. 2 is a schematic diagram depicting sample rate conversion performed in two separate stages;

FIG. 3 is a schematic block diagram depicting combined CD compensation and rate conversion in the frequency domain according to an aspect of the present disclosure; and

FIG. 4 is a detailed schematic block diagram depicting the combined CD and rate conversion shown in FIG. 3.

### DESCRIPTION OF EMBODIMENTS

The following merely illustrates the principles of the various embodiments. It will thus be appreciated that those skilled in the art will be able to devise various arrangements which, although not explicitly described or shown herein, embody the principles of the embodiments and are included within their spirit and scope.

Furthermore, all examples and conditional language recited herein are principally intended expressly to be only for pedagogical purposes to aid the reader in understanding the principles of the embodiments and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the FIGs., including functional blocks labeled as “processors” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the FIGs. are conceptual only. Their function may be carried out through the operation of program logic, through dedicated logic, through the interaction of program control and dedicated logic, or even manually, the particular technique being selectable by the implementor as more specifically understood from the context.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicants thus regard any means which can provide those functionalities as equivalent as those shown herein.

Unless otherwise explicitly specified herein, the drawings are not drawn to scale.

By way of some additional background, it is noted that chromatic dispersion (CD) compensation may be performed in either the optical domain or electrical domain. To mitigate CD in the optical domain, a dispersion compensating fiber (DCF) may be placed along a transmission path. As is known, DCF is a special type of fiber that acts to counteract CD effects. And while it may successfully suppress CD, DCF oftentimes exhibits high insertion loss thereby significantly reducing received signal power.

CD compensation may also be performed in the electrical domain—thanks in part to the availability of high speed analog-to-digital converters. Specifically, since the effect of CD can be modeled as ISI, various equalization techniques can be utilized to suppress CD and recover information from signals exhibiting CD. Among available equalization methods, a linear equalization method based on a finite impulse filter (FIR) has received considerable attention due—in part—to its simple structure and ability to successfully mitigate ISI. Of further advantage, the FIR method may be implemented either in a time domain or a frequency domain. However, the FIR method preferably operates at a symbol rate (or 1.5 times the symbol rate), which may be impractical in practice due to the unavailability of an ADC with a specific sampling rate.

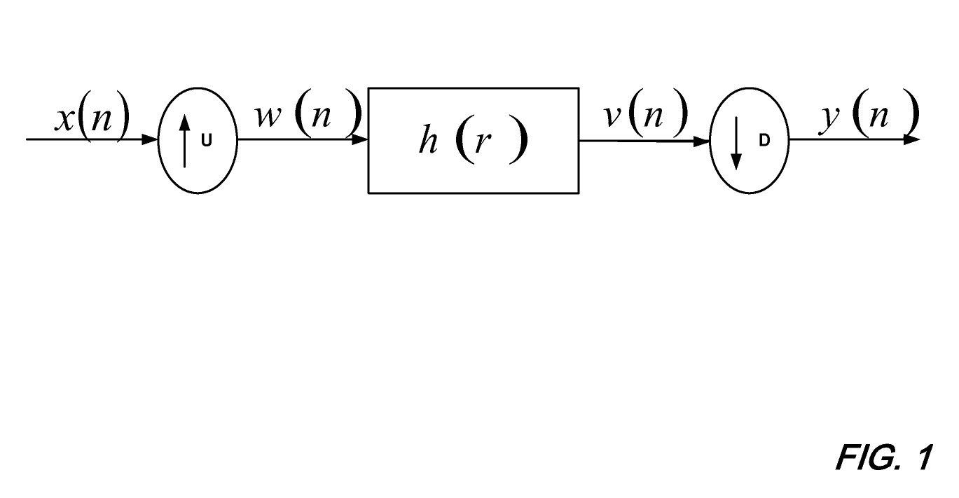

As may be appreciated, sample rate conversion may be carried out by a combined up-sampling (expander) and down-sampling (decimator) as shown schematically in FIG. 1. As shown in this figure, a signal x(n) has a sampling rate that need to be changed to U/D times the original sampling rate, where both U and D are integers. Operationally, U-1 zeroes are inserted into each input sample which raises the data rate to be U times the original sampling rate (w(n)). Next, a low-pass filter removes signal components having frequencies higher than a cut-off rate (v(n)). Finally, D-1 samples out of every D samples are discarded and any remaining samples are output (y(n).

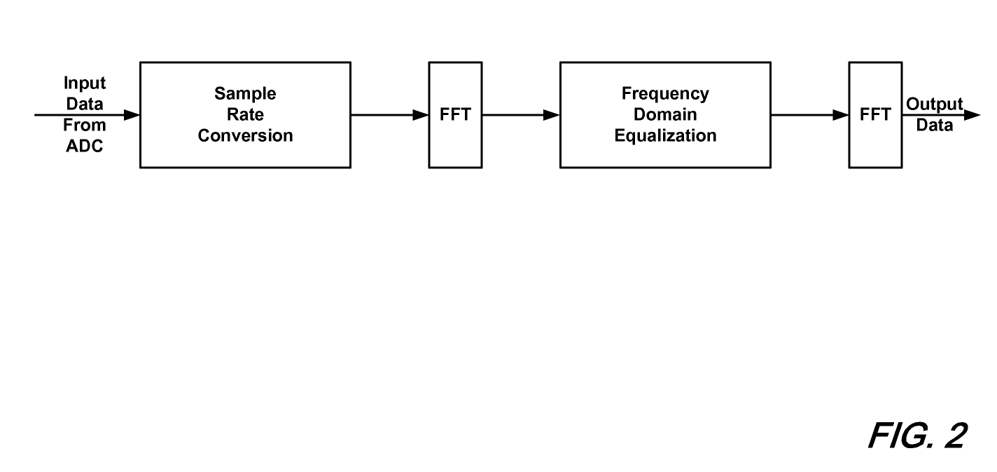

In a typical PolMux system, sample rate conversion and CD compensation are performed in two separate stages, such as that shown schematically in FIG. 2. With reference to that figure, it may be observed that input data received from an ADC undergoes a sample rate conversion, a fast-fourier transform (FFT), an equalization in the frequency domain, and finally an inverse FFT prior to output. Such an approach may encounter difficulties with synchronization and/or high-speed data transmission between the functional units.

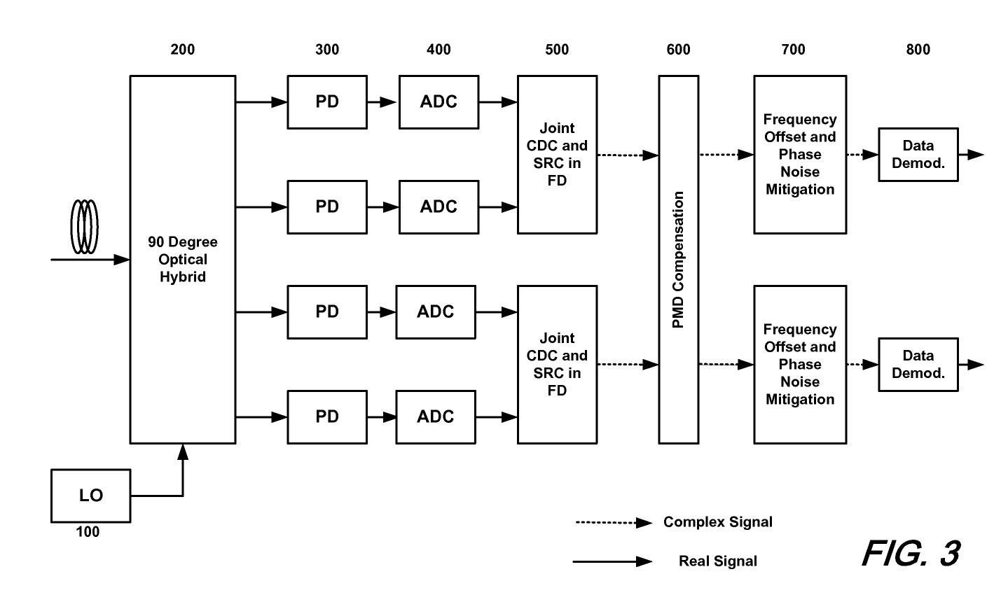

Turning now to FIG. 3, there it shows a schematic block diagram of a representative system which may perform a method according to the present invention. More particularly, a system to perform the joint CD compensation and rate conversion in the frequency domain.

As shown in that figure, an optical hybrid 200 driven by a local oscillator 100 receives optical signals which are presented and detected through the effect of photo-diodes 300 and digitized by analog-to-digital converter(s) 400. Samples resulting from the ADC operation are applied to a joint/combined CD compensation and sample rate conversion 500 operation. PMD compensation 600 is then performed on the compensated/converted signals followed by a frequency offset/phase noise mitigation operation 700. Finally, data demodulation 800 is performed to recover signals on original polarizations.

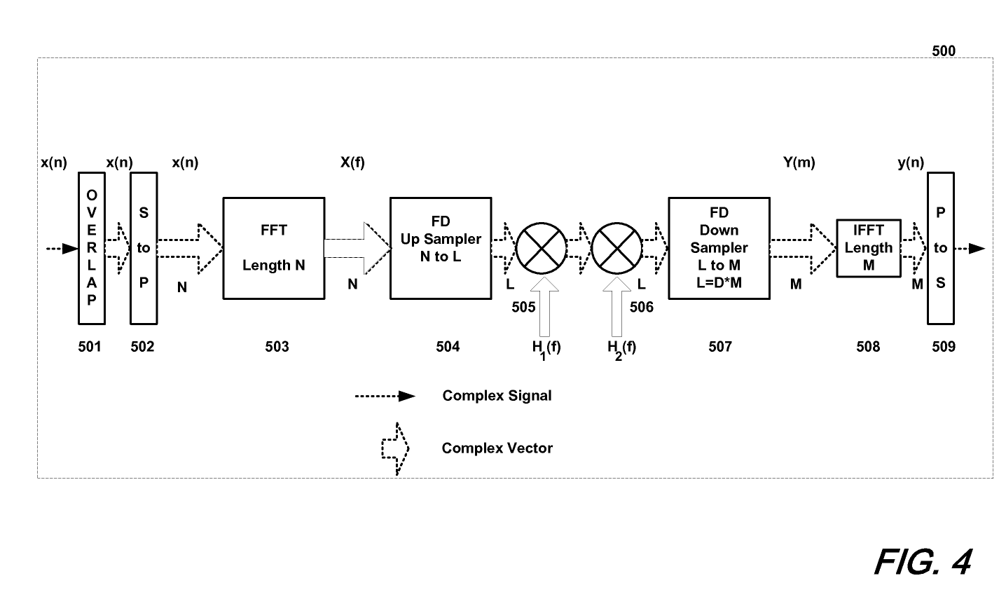

Turning now to FIG. 4 there is shown a detailed view of the joint/combined CD and rate conversion in the frequency domain according to an aspect of the present invention. More particularly, input samples are grouped into frames and there are N symbols in each frame. Each frame overlaps a previous frame by N₀ symbols 501. As may be readily understood and as used herein, N is the FFT size and N₀ is a constant. Both may be advantageously determined by the parameters U, D and also the channel delay spread.

Data contained in each of the frames is converted into parallel form on a frame-by-frame basis 502. Each frame is then converted into frequency-domain samples through the effect of FFT 503 according to the relationship:

X(m)=FFT[x(n),N] (1)

Next, the frequency domain samples are periodically extended U times to obtain a frequency domain sample having a block length of L=N*U 504 according to the following relationship:

X′(f)=X[ mod(f,N)] (2)

where
f={1,2, . . . , L}.

The obtained samples X′(f) are multiplied by a group of pre-calculated coefficients H₁(f) and H₂(f) 506 and then undergo a frequency domain down sampling operation 507 according to the following relationship:

$$y ( m ) = \frac{1}{D} {\sum }_{d = 0}^{d - 1} Y ( d M + 1 ) \\ where \\ m = \{ 1 , 2 , … , M \} . \qquad ( 3 )$$

As used herein, H₁ (f) is the frequency domain representation of a low pass filter having a cut-off frequency at the lowest of f₁/2 and f₀/2 where fᵢ and f₀ are the maximum frequencies of the input and output signals, respectively. H₂(f) is used to perform the CD compensation. Note that these two multiplications may be advantageously combined and simplified according to the following relationship:

Y′(f)=X′(f)H₁(f)H₂(f) (4)

The output of the frequency domain down conversion is a block of M samples, which are converted into the time domain through the effect of an IFFT 508. The resulting output is represented by:

y(n)=IFFT[Y(m),M] (5)

The first

$$[ \frac{{N}_{0} U}{D} ]$$

samples are discarded, and the remaining samples are subsequently converted into serial form 509.

At this point, while we have discussed and described the invention using some specific examples, those skilled in the art will recognize that our teachings are not so limited. Accordingly, the invention should be only limited by the scope of the claims attached hereto.

1. A joint method for the chromatic dispersion (CD) compensation and rate conversion of an optical signal comprising the steps of:
detecting and digitizing the optical signal; and
jointly compensating the digitized optical signal for CD and converting the sample rate.

2. The method of claim 1 further comprising the step of:
compensating the jointly compensated and rate converted signal for polarization mode dispersion.

3. The method of claim 2 further comprising the steps of:
grouping the digitized optical signal samples into frames;
converting on a frame by frame basis serial frame data into parallel frame data
converting each of the parallel frames into the frequency domain through the effect of an FFT;
extending the converted frequency domain frames;
multiplying the extended frames by a pair of pre-defined coefficients;
down sampling the multiplied extended frames;
converting each of the down sampled frames into the time domain through the effect of an inverse fourier transform (IFFT);
discarding a number of the transformed samples; and
converting the remainder through the effect of a parallel to serial converter.
